(19) United States
(12) Patent Application Publication
(10) Pub. No.: US 2025/0016047 A1
(43) Pub. Date: Jan. 9, 2025

(54) ORCHESTRATOR APPARATUS, COMMUNICATION SYSTEM, APPLICATION DEPLOYMENT DETERMINATION METHOD, AND STORAGE MEDIUM

(71) Applicant: Mitsubishi Electric Corporation, Tokyo (JP)

(72) Inventors: Takeshi SUEHIRO, Tokyo (JP); Takashi Asahara, Tokyo (JP); Shingo Ryu, Tokyo (JP); Tatsuya Yokoyama, Tokyo (JP); Shusaku Umeda, Tokyo (JP); Mari Ochiai, Tokyo (JP); Kenichi Nakura, Tokyo (JP)

(73) Assignee: Mitsubishi Electric Corporation, Tokyo (JP)

(21) Appl. No.: 18/891,133

(22) Filed: Sep. 20, 2024

Related U.S. Application Data
(63) Continuation of application No. PCT/JP2022/017112, filed on Apr. 5, 2022.

(51) Int. Cl. H04L 41/0813; H04L 41/0894; H04W 64/00

(52) U.S. Cl. CPC H04L 41/0813; H04L 41/0894; H04W 64/00

(57) ABSTRACT

An edge orchestrator is an orchestrator apparatus for dynamically deploying, to at least one edge server and at least one cloud server, one or more applications that provide one or more services to at least one user equipment. The edge orchestrator includes an app deployment determination unit that determines, upon detection of a state in which a determination of deployment of the one or more applications is necessary, the deployment of the one or more applications on the basis of: a location of each user equipment that uses the one or more services; the maximum number of sessions that is the upper limit of the number of sessions allowed to be simultaneously set for each one user equipment that uses the one or more services; and a requirement of the service provided by each application to be deployed.

### CROSS-REFERENCE TO RELATED APPLICATION

This application is a continuation application of International Application PCT/JP2022/017112, filed on Apr. 5, 2022, and designating the U.S., the entire contents of which are incorporated herein by reference.

### BACKGROUND OF THE INVENTION

### 1. Field of the Invention

The present disclosure relates to an orchestrator apparatus for determining the deployment of an application that provides a service to a user equipment, a communication system, an application deployment determination method, and a storage medium.

### 2. Description of the Related Art

Cloud computing, which has become widespread, deploys applications to groups of servers installed in a large-scale facility called a data center and provides services through the Internet. On the other hand, edge computing, which has been proposed, installs (groups of) servers for deployment of applications closer to a user on a network to thereby enable reduction in communication latency and reduction in load on a trunk network as compared with the cloud computing.

The edge computing involves selecting a server for the deployment of the application, from the groups of servers distributed/disposed in multiple locations over the network in order to satisfy service network requirements. The edge computing further involves changing the server for the deployment of the application in accordance with time-dependent changes that occur in deployment states and usage states of resources of the network and the servers, in a user location, and in a service used by a user.

Non Patent Literature 1, “ETSI GS MEC 003 V2.1.1 (2019-01)”, provides a framework and an architecture for implementing such change to the deployment of the application. For example, Japanese Patent Application Laid-open No. 2011-103567 discloses a system that, when a terminal in a mobile communication network is handed over, determines, on the basis of network communication quality between the post-handover terminal and a server, whether to change the server for the deployment of the application to another server.

In a case where there is a plurality of services that the user wants to use, it is possible that applications for the services are distributed in a plurality of groups of servers on the network if the different services involve different requirements. Additionally, even if the services involve similar requirements, it is also possible that servers to which the applications are deployed at some point in time vary depending on resource states of the network and the servers and past histories of the deployment of the applications.

For 3GPP TS23.548 V17.0.0, distributed anchor point, multiple Protocol Data Unit (PDU) sessions, and session breakout are defined as three types of connectivity models for edge computing in a mobile communication network. In the former two types of connectivity models, a User Equipment (UE) needs to establish a session for each point of attachment to a Data Network (DN) that is an external network via the mobile communication network. That is, the UE needs to establish a session for each edge network to which an edge server belongs and a session for each usual point of attachment to the Internet.

On the other hand, the number of sessions allowed to be simultaneously established for the UE has an upper limit. Thus, the user is not allowed to use all the services when the applications for the services that the user wants to use are distributed in the edge networks or the clouds beyond the upper limit of the number of sessions allowed to be simultaneously established for the UE.

### SUMMARY OF THE INVENTION

To solve the above problem, the present disclosure provides an orchestrator apparatus to dynamically deploy, to at least one edge server and at least one cloud server, one or more applications to provide one or more services to at least one user equipment, the orchestrator apparatus comprising: an app deployment determination unit to determine, upon detection of a state in which a determination of deployment of the one or more applications is necessary, the deployment of the one or more applications on a basis of: a location of each user equipment to use the one or more services; a maximum number of sessions that is an upper limit of the number of sessions allowed to be simultaneously set for each one user equipment to use the one or more services; and a requirement of the service provided by each application to be deployed.

### BRIEF DESCRIPTION OF THE DRAWINGS

FIG. 1 is a diagram illustrating an exemplary configuration of a communication system implemented by applying an edge orchestrator according to an embodiment;

FIG. 2 is a block diagram illustrating a functional configuration of the edge orchestrator according to the embodiment;

FIG. 3 is a diagram illustrating a state of the communication system before relocation of deployment of an application;

FIG. 4 is a diagram illustrating a state of the communication system after the relocation of the deployment of the application;

FIG. 5 is a flowchart illustrating an example of operations of the edge orchestrator according to the embodiment; and

FIG. 6 is a diagram illustrating an example of hardware that implements the edge orchestrator according to the embodiment.

### DETAILED DESCRIPTION OF THE PREFERRED EMBODIMENTS

Hereinafter, with reference to the drawings, a description will be given in detail of an orchestrator apparatus, a communication system, an application deployment determination method, and a storage medium according to an embodiment of the present disclosure. Embodiment.

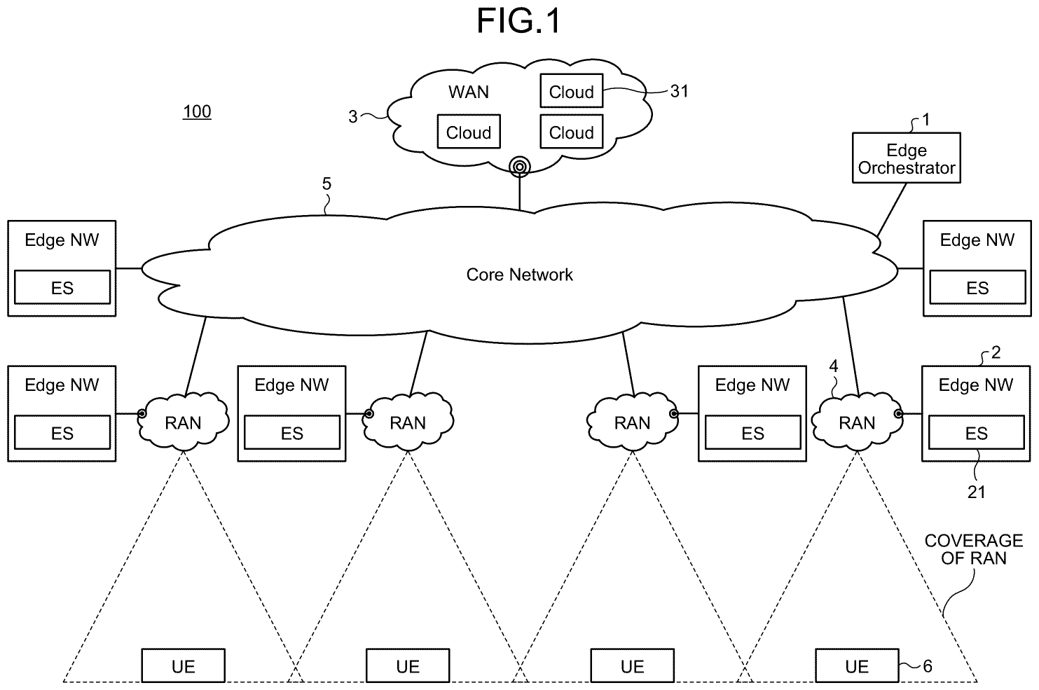

FIG. 1 is a diagram illustrating an exemplary configuration of a communication system 100 implemented by applying an edge orchestrator 1 according to the embodiment.

The communication system 100 includes the edge orchestrator 1 that is an orchestrator apparatus, edge networks (Edge NWs) 2, a Wide Area Network (WAN) 3, Radio Access Networks (RANs) 4, a core network 5, and UEs 6. In the communication system 100, the edge orchestrator 1 deploys, to edge servers(ES) 21 defining the edge networks 2 or cloud servers (clouds) 31 defining the WAN 3, server-side applications for services received by users who use the UEs 6. Note that in the following description, the edge network and the application are sometimes referred to as an “edge” and an “app”, respectively.

A mobile network including the edge networks 2 and the RANs 4 under the core network 5 is operated by one or a plurality of operators. The WAN 3 is a network in which systems of the plurality of operators are connected to each other. The WAN 3 includes the Internet in addition to the cloud servers 31 illustrated.

The UEs 6 are each a user equipment such as a smartphone, a tablet, or an in-vehicle equipment. The UE 6 is connected to the edge server 21 or the cloud server 31 to which the application is deployed, such that the user who uses the UE 6 can receive the service.

The RANs 4 each include a so-called base station. For convenience, in the following description, the RANs 4 are sometimes referred to as base stations 4. The RANs 4, which are wirelessly connected to the UEs 6 located in coverage of the respective RANs 4, transmit, to the core network 5, signals received from the UEs 6 and addressed to the WAN 3 or signals received from the UEs 6 and addressed to the edges 2 connected to the core network 5, and transmit, to the UEs 6, signals received from the core network 5 and addressed to the UEs 6. Additionally, the base station 4 is also connected to the near edge 2, transmits, to the near edge 2, signals received from the UE 6 and addressed to the near edge 2, and transmits, to the UE 6, signals received from the near edge 2 and addressed to the UE 6. Note that, specifically, the communication between the base station 4 and the near edge 2 is also performed via a signal transfer function (also deployed near the base stations 4) among functions of the core network 5 to be described later, but this is not illustrated.

In addition to the signal transfer between the base stations 4 and external networks (including the WAN 3 and the edges 2), the core network 5 has functions such as registration and authentication of the UEs 6, location management, and establishment and control of communication paths (including PDU sessions) between the UEs 6 and the external networks. The core network 5 also has functions of providing information in the mobile network to an application outside the mobile network, and enabling the outside application to control the mobile network.

The edges 2 are each connected to the base station 4 or the core network 5, and each include the edge server 21 in which server an application is deployed and processing for providing a service to the UE 6 is performed. Note that, although the edges 2 may each include a plurality of edge servers 21, FIG. 1 illustrates only one edge server 21 included in each edge network 2.

The edge orchestrator 1 provides an instruction for deployment of the application or change to the deployment of the application and notifies the mobile network of a necessary session, on the basis of network and server requirements of services provided to the UE 6 via the mobile network, resource information on the mobile network, resource information on the edge server 21, location information on the UE 6, use or no use of the service by the UE 6, and information on the maximum number of sessions for the UE 6. The maximum number of sessions for the UE 6 is the upper limit of the number of sessions allowed to be simultaneously set for the UE 6. Note that, the deployment of the application includes not only whether to deploy the application to each server but also how many server resources should be allocated to the application when the application is deployed. For example, Non Patent Literature 1, “ETSI GS MEC 003 V2.1.1 (2019-01)”, discloses controlling such resource allocation amounts, and various methods can be considered for computing the resource allocation amounts. An example of the methods includes a method of computing the resource allocation amounts based on the number of the UEs 6 because it is considered that more resources are required as the number of the UEs 6 connected to each server is larger. Hereinafter, a description will be given focusing on whether to perform the deployment.

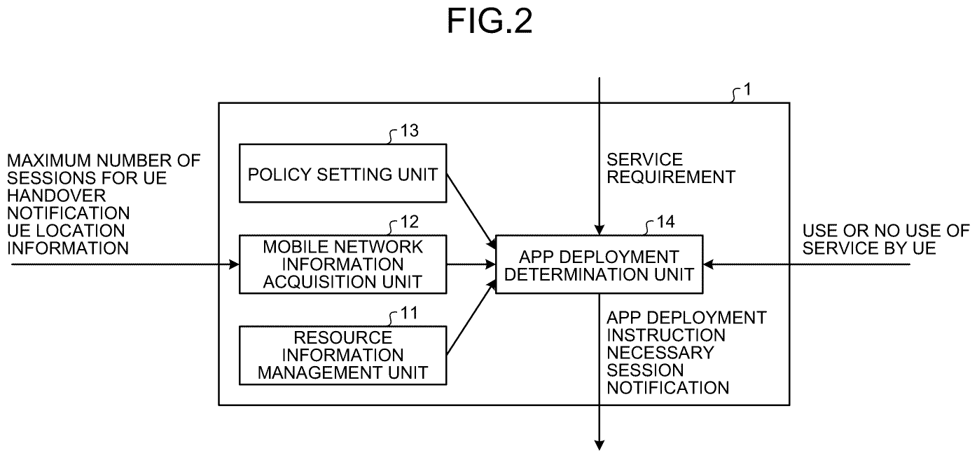

FIG. 2 is a block diagram illustrating a functional configuration of the edge orchestrator 1 according to the embodiment. The edge orchestrator 1 includes a resource information management unit 11, a mobile network information acquisition unit 12, a policy setting unit 13, and an app deployment determination unit 14.

The resource information management unit 11 manages, for example, network locations of each edge server 21 and each cloud server 31, amounts of communication latency between the UE 6 and each edge server 21 and each cloud server 31, information on deployment states and usage states (or availability states) of resources (including a computation resource, a memory resource, and a storage resource) of each edge server 21, deployment states of resources (including a communication band from the UE 6 to each cloud server 31 and a communication band from the UE 6 to each edge server 21) of the mobile network, and information on the usage states (or availability states) of the resources of the mobile network.

The mobile network information acquisition unit 12 acquires a location of and the maximum number of sessions for each UE 6, and information on resources (including the communication bands from the UE 6 to each cloud server 31 and from the UE 6 each edge server 21) of the mobile network. Additionally, the mobile network information acquisition unit 12 receives a handover notification about the handover of the UE 6.

The policy setting unit 13 holds policies related to the deployment of the application and the change to the deployment of the application. The policies provide that, for example, the server to which the application is deployed should be set to the highest possible level among the cloud servers 31 and the edge servers 21, and the servers to which the applications for identical services are deployed should be reduced in number as much as possible (i.e., should not be distributed).

In response to the handover of the UE 6, the change to a service usage state of the UE 6, and the start of the provision of a new service, the app deployment determination unit 14 determines the deployment of the application on the basis of: the requirements of the services; the information managed by the resource information management unit 11; the UE information acquired by the mobile network information acquisition unit 12; and the policies related to the deployment of the application held by the policy setting unit 13. Additionally, the app deployment determination unit 14 manages, for each service, the requirement of the service, the UE 6 using the service, and information on the deployment of the application for the service. The information on the deployment of the application for the service includes information indicating in which server the application for the service is deployed, and information indicting to which server each UE using the service is connected to receive the service. The UE information, which is information related to the UE 6, includes information on, for example, the number of sessions allowed to be simultaneously set for the UE 6, a current location of the UE 6, and a base station to which the UE 6 is connected. The requirement of the service is, for example, a request latency, a required band, a required resource, a provision area, or the like. The app deployment determination unit 14 further instructs, as appropriate, the edge server 21 and the cloud server 31 to deploy and redeploy the application and notifies the mobile network of a necessary session between the UE 6 and the edge server 21 or the cloud server 31.

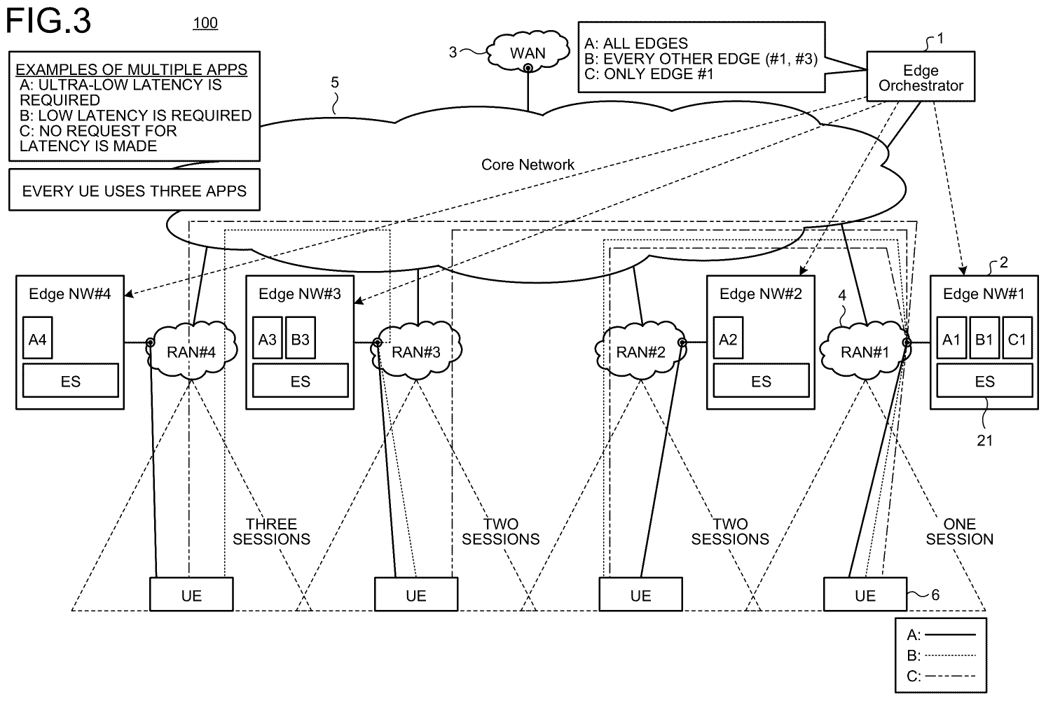

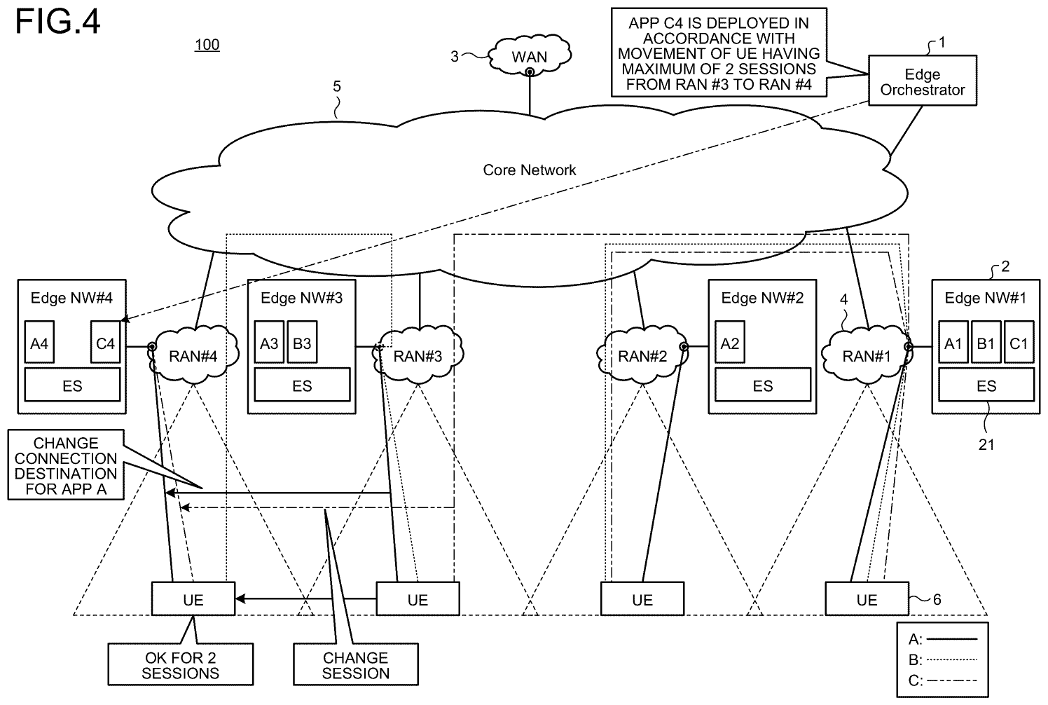

Next, with reference to FIGS. 3 and 4, a description will be given of an example of processing in which the edge orchestrator 1 of the communication system 100 relocates the deployment of the applications. FIG. 3 is a diagram illustrating a state of the communication system 100 before the change to the deployment of the application, and FIG. 4 is a diagram illustrating a state of the communication system 100 after the change to the deployment of the application. Note that, FIGS. 3 and 4 omit the illustration of some of the edge networks 2 and the cloud servers 31 of the WAN 3, which are included in the communication system 100 in FIG. 1.

In order to simplify the description, this example is based on assumption that the edge server 21 of the edge network 2 connected to each base station (RAN 4) is a candidate for the server to which the application is deployed. Of course, typically, the edge server 21 connected to the core network and the cloud server 31 of the WAN are also candidates for the servers to which the applications are deployed, and the idea described below is also applicable where such candidates are included. Note that, in the following description, as illustrated in the figure, the plurality of edge networks 2 may be referred to as edge networks #1 to #4 to distinguish from each other, and the plurality of RANs 4 may be referred to as RANS #1 to #4 to distinguish from each other. The edge networks #1 to #4 are connected to the RANs #1 to #4, respectively. Additionally, assume that each of the edge networks 2 includes one edge server 21.

This example is based on the assumption that three types of services A, B, and C are provided: a service requiring ultra-low latency communication (=service A); a service requiring low latency communication (=service B); and a service involving no particular request for communication latency (=service C). Here, the ultra-low latency can be implemented with the edge 2 near the RAN 4 accommodating each UE 6, and the low latency can be implemented with the edge 2 near the RAN 4 adjacent to the RAN 4 accommodating each UE 6. Thus, in FIG. 3, the edge orchestrator 1 deploys applications to all the four edges #1 to #4 for the service A, deploys applications to every other edge for the service B (here, edges #1 and #3), and deploys an application to only one edge for the service C (here, edge #1). In FIG. 3, quadrangles denoted by A1 to A4 each indicate the application for the service A, quadrangles denoted by B1 and B3 each indicate the application for the service B, and a quadrangle denoted by C1 indicates the application for the service C. Note that, in a case where the edge network 2 is defined by the plurality of edge servers 21, the application may be deployed in any one of the edge servers 21 of the edge network 2. To which edge server 21 the application is to be deployed is determined on the basis of, for example, the deployment states, the usage states, etc. of the resources of the respective edge servers 21. The same applies to FIG. 4.

Note that, although the coverage of each of the RANs #1 to #4 actually extends two-dimensionally, the one-dimensional coverage is described here for the sake of simplicity. Additionally, assume that every UE 6 receives all the three types of services A to C. As described above, since the UE 6 needs to establish a session for each external network connected thereto, each UE 6 needs to establish a session or sessions as many as the number illustrated in FIG. 3. That is, the UE 6 connected to the RAN #1 needs to establish one session, specifically, a session with the edge #1 for receiving the services A to C. The UE 6 connected to the RAN #2 needs to establish two sessions, specifically, a session with the edge #2 for receiving the service A and a session with the edge #1 for receiving the services B and C. The UE 6 connected to the RAN #3 needs to establish two sessions, specifically, a session with the edge #3 for receiving the services A and B and a session with the edge #1 for receiving the service C. The UE 6 connected to the RAN #4 needs to establish three sessions, specifically, a session with the edge #4 for receiving the service A, a session with the edge #3 for receiving the service B, and a session with the edge #1 for receiving the service C.

Consider a situation where the UE 6 connected to the RAN #3 moves and is handed over to the RAN #4. Additionally, assume that the maximum number of sessions, which is the upper limit of the number of sessions allowed to be simultaneously set for the UE 6 connected to the RAN #3, is two, and the edge orchestrator 1 knows that maximum number in advance. Examples of a method by which the edge orchestrator 1 knows the maximum number of sessions for each UE 6 include a method of acquiring information on the maximum number of sessions for each UE 6 from the mobile network because the mobile network can know the information on the maximum number of sessions for the UE 6 at the time of registering the UE 6. Of course, without depending on this method, the following method may alternatively be employed: the maximum number of sessions for each UE 6 may be separately set in the edge orchestrator 1, and only information (e.g., ID) on the UE 6 present in the service area may be acquired from the mobile network. Further alternatively, another method may be employed.

The edge orchestrator 1 is notified by the mobile network that the UE 6 is to be handed over from the RAN #3 to the RAN #4. The edge orchestrator 1, which knows how the applications are deployed to the edges 2 (edges #1 to #4) and that the maximum number of sessions for that UE 6 is two, determines that the UE 6 cannot continuously receive the three types of services in the RAN #4 that is a destination of the handover of the UE, instructs each edge 2 to redeploy the applications, and instructs the mobile network to establish the session such that the UE 6 can be connected to the edges 2 that have redeployed the applications. FIG. 4 illustrates an example of the redeployment, and the edge orchestrator 1 deploys the application for the service C to the edge #4.

As described above, upon being notified of the handover of the UE 6, the edge orchestrator 1 determines whether the UE 6 that should be handed over can continuously use the services that are currently in use without change to the deployment of the application for each service. This determination is made on the basis of the deployment of the applications and the maximum number of sessions for the UE 6. In a case where the UE 6 cannot continuously use the services for lack of the number of sessions, the edge orchestrator 1 changes the deployment of the applications such that the UE 6 can continuously receive the necessary services with the maximum number of sessions for the UE 6. As described above, the deployment of applications with the maximum number of sessions for the UE 6 taken into consideration allows the UE 6 to receive the plurality of services even if the UE 6 has a limitation on the number of sessions allowed to be simultaneously set.

The handover notification may precede the actual handover or be simultaneous with or follow the handover. However, in some case, the handover notification is required to precede the actual handover, depending on an allowable service suspension period because it takes time to change the deployment of the applications after the handover notification. In order to shorten the time from the handover notification to the instruction for the change to the deployment of the applications, the edge orchestrator 1 may compute in advance the deployment of the applications, providing for the occurrence of the handover to the RAN 4 that is a possible destination of the handover. The RANs 4, which are the possible handover destinations, are expected to be the RANs 4 having adjacent coverages. In a case where the UE 6 is, for example, an in-vehicle equipment, it is expected that the edge orchestrator 1 separately holds map information and compares the map information with the coverage information, thus making it possible to further narrow down the RANs 4 that are the possible handover destinations. Additionally, the edge orchestrator 1 may deploy the applications before the handover notification. Instead of receiving the handover notification from the mobile network, the edge orchestrator 1 may estimate the handover from the location information on the UE 6 and the coverage information. Alternatively, the edge orchestrator 1 may use both the reception of the handover notification and the estimation of the handover in combination. The edge orchestrator 1 may acquire the location information on the UE 6 from the mobile network or from another system that is collecting the location information from the UE 6.

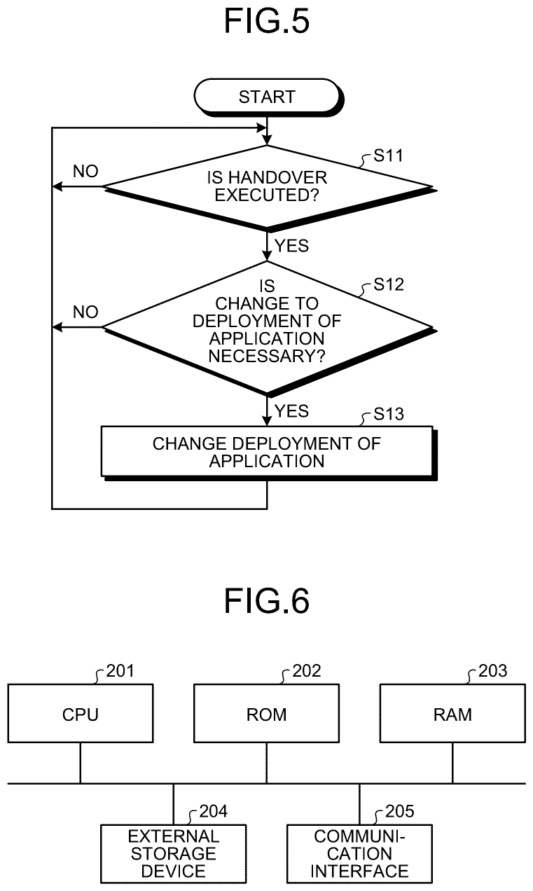

An example of operations of the edge orchestrator 1 described above is illustrated in a flowchart of FIG. 5. FIG. 5 is a flowchart illustrating an example of operations of the edge orchestrator 1 according to the embodiment.

First, the app deployment determination unit 14 of the edge orchestrator 1 checks whether the handover of the UE 6 is executed, that is, whether the mobile network information acquisition unit 12 has received, from the mobile network, a notification indicating that the UE 6 is handed over (step S11). When no handover of the UE 6 is executed (step S11: No), the app deployment determination unit 14 repeats checking whether the handover is executed. When the handover of the UE 6 is executed (step S11: Yes), the app deployment determination unit 14 checks whether the change to the deployment of the applications is necessary, that is, whether the UE 6 that is to be handed over can continuously receive the services even after the UE 6 has been handed over (step S12). When the change to the deployment of the applications is necessary (step S12: Yes), the app deployment determination unit 14 changes the deployment of the applications (step S13). In step S13, as described above, the app deployment determination unit 14 changes the deployment of the applications such that the UE 6 having been handed over can use the services which had been used before the UE 6 was handed over, in the sessions the number of which is less than or equal to the maximum number of sessions. After the execution of step S13 and when the change to the deployment of the applications is unnecessary (step S12: No), the app deployment determination unit 14 returns to step S11 and repeats the operations of steps S11 to S13.

In the above-described example, there is a probability that the application for the service C cannot be redeployed to the edge #4, depending on the states of the resources of the edge #4 and the states of the resources of the mobile network. The app deployment determination unit 14 of the edge orchestrator 1 can acquire the states of the resources of the edges #1 to #4 and the states of the resources of the mobile network before computing the deployment of the applications, and can compute the redeployment of the applications, using these states as constraints. For example, in a case where the edge #4 does not have sufficient resources but the edge #3 has sufficient resources, the app deployment determination unit 14 can deploy the application for the service C to the edge #3 instead of the edge #4. Furthermore, the service provided by the application considered being redeployed is not limited to the service that cannot be continuously provided to the UE 6 unless the redeployment is performed. In particular, in the case of insufficient resources, the redeployment of the applications including other services is computed to thereby possibly achieve the deployment that allows for continuously providing all the UEs 6 with necessary services. To the contrary, no matter how the applications are redeployed, in some case, it is impossible to continuously provide all the UEs 6 with necessary services. In such a case, the edge orchestrator 1 may notify the UEs 6 disallowed to continuously receive the services that the services cannot be continuously provided. The edge orchestrator 1 may notify a service provider that it is impossible to continuously provide such a service provider with the services. As described above, an attempt is made to compute the deployment for the potential handover in advance, but it is turned out that the services cannot be continuously provided, in which case the notification to that effect can be provided before the handover.

On the other hand, there may be different ways of deployment of applications that can continuously provide each UE 6 with the services. In such a case, the app deployment determination unit 14 of the edge orchestrator 1 determines the deployment in accordance with the policies set in the policy setting unit 13. For example, because the redeployment of the applications may affect continuity of the service, the policies to be considered are to select redeployment that involves as little change as possible, select redeployment with leveled utilization of resources, etc.

Additionally, in the above example, it is necessary to deploy an additional application in accordance with the handover of the UE 6. However, conversely, there is a case where the deployed application is no longer needed. In such a case, the edge orchestrator 1 may delete the application that is no longer needed.

Although the above description has been made as to the applications being redeployed in response to the handover of the UE 6, it is also conceivable that the service received by the UE 6 is added or deleted in which case the edge orchestrator 1 may redeploy the applications as appropriate in the same manner. That is, in step S11 of FIG. 5, the app deployment determination unit 14 may check whether the service used by the UE 6 is changed (addition or deletion of the service) in addition to checking whether the handover of the UE 6 is executed, and may execute step S12 when the handover is executed or the service used by the UE 6 is changed. For example, upon request of a user of the UE 6, an administrator of the edge orchestrator 1 may set, in the edge orchestrator 1, whether the UE 6 uses the service, and change the setting. Alternatively, such setting and change may be performed by a service that manages whether to use the service. In the latter case, that management service should be used as a precondition. Such a service is considered to have no particular latency requirement, and thus, it is necessary to, for example, deploy services in a centralized manner to the cloud server 31 so as to allow the UE 6 to be connectable thereto at any time. The requirement of the service may include whether the UE 6 uses the service.

Next, with reference to FIG. 6, a description will be given of a hardware configuration of the edge orchestrator 1 according to the present embodiment. FIG. 6 is a diagram illustrating an example of hardware that implements the edge orchestrator 1 according to the embodiment. The edge orchestrator 1 includes, for example, hardware having the configuration illustrated in FIG. 6, that is, a Central Processing Unit (CPU) 201, a Read Only Memory (ROM) 202, a Random Access Memory (RAM) 203, an external storage device 204 such as a Hard Disk Drive (HDD), and a communication interface 205. These components are connected to each other through a bus. The CPU 201 is a control circuit that performs overall processing and control of the edge orchestrator 1. The ROM 202 or the external storage device 204 stores programs such as a boot program, a communication program, and a data analysis program. The RAM 203 is used as a work area of the CPU 201. The communication interface 205 is connected to an external device.

The functions of the units (illustrated in FIG. 2) of the edge orchestrator 1 are implemented by software, firmware, or a combination of software and firmware. Software and firmware for implementing each unit of the edge orchestrator 1 are described as programs and stored in the ROM 202 or the external storage device 204. As a result of the CPU 201 reading and executing the above-described programs stored in the ROM 202 or the external storage device 204, the functions of the resource information management unit 11, the mobile network information acquisition unit 12, the policy setting unit 13, and the app deployment determination unit 14 of the edge orchestrator 1 are implemented.

For example, the programs that are stored in the ROM 202 or the external storage device 204 and described for implementing the units of the edge orchestrator 1 may be provided to a user or the like by being stored in a storage medium such as a Compact Disc (CD)-ROM or a Digital Versatile Disc (DVD)-ROM, or may be provided via a network.

As described above, in the communication system 100 according to the present embodiment, the edge orchestrator 1 changes the deployment of each application on the basis of the maximum number of sessions for each UE 6, the RAN 4 to which each UE 6 is connected, and the requirement of each service used by each UE 6 when it is necessary to change the deployment of the applications that provide services to each UE 6 connected to the RAN 4. This can implement a communication system capable of simultaneously providing services that outnumbers the upper limit of the number of sessions allowed to be simultaneously set.

The orchestrator apparatus according to the present disclosure has an effect of implementing the communication system capable of simultaneously providing the UE with the services, the UE having the limitation on the number of sessions allowed to be simultaneously set, the services outnumbering the upper limit of the number of sessions allowed to be simultaneously set.

The configurations described in the above embodiment are illustrative only and may be combined with the other known techniques, and part of each of the configurations may be omitted or modified without departing from the gist.

What is claimed is:

1. An orchestrator apparatus to dynamically deploy, to at least one edge server and at least one cloud server, one or more applications to provide one or more services to at least one user equipment, the orchestrator apparatus comprising:
a processor to execute a program; and
a memory to store the program which when executed by the processor performs:
an app deployment determination process of determining, upon detection of a state in which a determination of deployment of the one or more applications is necessary, the deployment of the one or more applications on a basis of: a location of each user equipment to use the one or more services; a maximum number of sessions that is an upper limit of the number of sessions allowed to be simultaneously set for each one user equipment to use the one or more services; and a requirement of the service provided by each application to be deployed.

2. The orchestrator apparatus according to claim 1, wherein
the app deployment determination process determines, when the at least one user equipment is handed over, whether change to the deployment of the one or more applications is necessary, and changes the deployment when the change is necessary.

3. The orchestrator apparatus according to claim 1, wherein
the app deployment determination process determines, when the one or more services used by the at least one user equipment are changed, whether change to the deployment of the one or more applications is necessary, and changes the deployment when the change is necessary.

4. The orchestrator apparatus according to claim 2, wherein
the app deployment determination process determines, when the one or more services used by the at least one user equipment are changed, whether change to the deployment of the one or more applications is necessary, and changes the deployment when the change is necessary.

5. The orchestrator apparatus according to claim 1, wherein when executed by the processor, the program further performs:
a resource information management process of managing a network location of each edge server, an amount of a communication latency between the at least one user equipment and each edge server, a deployment state and a usage state, of a resource of each edge server, and a deployment state and a usage state of, a resource of a mobile network;
a mobile network information acquisition process of acquiring, from the mobile network, location information on the at least one user equipment and the maximum number of sessions for each user equipment; and
a policy setting process of holding policies related to the deployment and change to the deployment of, the one or more applications, wherein
the app deployment determination process determines the deployment of the one or more applications on a basis of the information managed by the resource information management process, the location information and the maximum number of sessions acquired by the mobile network information acquisition process, the policies, and the requirements.

6. The orchestrator apparatus according to claim 2, wherein when executed by the processor, the program further performs:
a resource information management process of managing a network location of each edge server, an amount of a communication latency between the at least one user equipment and each edge server, a deployment state and a usage state, of a resource of each edge server, and a deployment state and a usage state of, a resource of a mobile network;
a mobile network information acquisition process of acquiring, from the mobile network, location information on the at least one user equipment and the maximum number of sessions for each user equipment; and
a policy setting process of holding policies related to the deployment and change to the deployment of, the one or more applications, wherein
the app deployment determination process determines the deployment of the one or more applications on a basis of the information managed by the resource information management process, the location information and the maximum number of sessions acquired by the mobile network information acquisition process, the policies, and the requirements.

7. The orchestrator apparatus according to claim 3, wherein when executed by the processor, the program further performs:
a resource information management process of managing a network location of each edge server, an amount of a communication latency between the at least one user equipment and each edge server, a deployment state and a usage state, of a resource of each edge server, and a deployment state and a usage state of, a resource of a mobile network;
a mobile network information acquisition process of acquiring, from the mobile network, location information on the at least one user equipment and the maximum number of sessions for each user equipment; and
a policy setting process of holding policies related to the deployment and change to the deployment of, the one or more applications, wherein
the app deployment determination process determines the deployment of the one or more applications on a basis of the information managed by the resource information management process, the location information and the maximum number of sessions acquired by the mobile network information acquisition process, the policies, and the requirements.

8. The orchestrator apparatus according to claim 4, wherein when executed by the processor, the program further performs:
a resource information management process of managing a network location of each edge server, an amount of a communication latency between the at least one user equipment and each edge server, a deployment state and a usage state, of a resource of each edge server, and a deployment state and a usage state of, a resource of a mobile network;
a mobile network information acquisition process of acquiring, from the mobile network, location information on the at least one user equipment and the maximum number of sessions for each user equipment; and
a policy setting process of holding policies related to the deployment and change to the deployment of, the one or more applications, wherein
the app deployment determination process determines the deployment of the one or more applications on a basis of the information managed by the resource information management process, the location information and the maximum number of sessions acquired by the mobile network information acquisition process, the policies, and the requirements.

9. A communication system comprising:
the orchestrator apparatus according to claim 1; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

10. A communication system comprising:
the orchestrator apparatus according to claim 2; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

11. A communication system comprising:
the orchestrator apparatus according to claim 3; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

12. A communication system comprising:
the orchestrator apparatus according to claim 4; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

13. A communication system comprising:
the orchestrator apparatus according to claim 5; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

14. A communication system comprising:
the orchestrator apparatus according to claim 6; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

15. A communication system comprising:
the orchestrator apparatus according to claim 7; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

16. A communication system comprising:
the orchestrator apparatus according to claim 8; and
a mobile network to manage the location information on and the maximum number of sessions for the at least one user equipment and to notify the orchestrator apparatus of the location information and the maximum number of sessions, wherein when the at least one user equipment is handed over, the mobile network notifies the orchestrator apparatus of the location information on the at least one user equipment having been handed over.

17. An application deployment determination method for dynamically deploying, to at least one edge server and at least one cloud server, one or more applications to provide one or more services to at least one user equipment, the method comprising:
detecting a state in which a determination of deployment of the one or more applications is necessary; and
determining the deployment of the one or more applications on a basis of: a location of each user equipment to use the one or more services; a maximum number of sessions that is an upper limit of the number of sessions allowed to be simultaneously set for each user equipment to use the one or more services; and a requirement of the service provided by each application to be deployed.

18. A non-transitory storage medium storing a control program for an orchestrator apparatus to dynamically deploy, to at least one edge server and at least one cloud server, one or more applications to provide one or more services to at least one user equipment, the control program causing the orchestrator apparatus to execute:
detecting a state in which a determination of deployment of the one or more applications is necessary; and
determining the deployment of the one or more applications on a basis of: a location of each one user equipment to use the one or more services; the maximum number of sessions that is an upper limit of a number of sessions allowed to be simultaneously set for each one user equipment to use the one or more services; and a requirement of the service provided by each application to be deployed.
